(19) United States
(12) Patent Application Publication
(10) Pub. No.: US 2006/0033252 A1
(43) Pub. Date: Feb. 16, 2006

(54) Sigma Sigma-springs for suspension systems

(76) Inventor: Salah Ahmed Mohamed Elmoselhy, Cairo (EG)

Correspondence Address: Salah Ahmed Mohamed Elmoselhy, 6 Zenabden st., Sydazenab, Cairo 11461, Cairo, EG

(21) Appl. No.: 10/917,011

(22) Filed: Aug. 13, 2004

(51) Int. Cl. F16F 1/20

(52) U.S. Cl. 267/165

(57) ABSTRACT

Sigma Σ-spring is a spring of a Sigma Σ-shape resembles the capital Sigma Σ letter, above which mass can be suspended vertically while under static or dynamic loading conditions. The outer two arms of the Σ-shape of the spring are inclined such mat to be horizontal while fully loaded ensuring safe compression pattern and providing pre-stressed condition that reduces stress at critically stressed sections. The Σ-shape has two opposite sets of turns of different sizes one of small radius of curvature at the side of line of loading of the mass that can be suspended vertically and the opposite one has large radius of curvature in order to maximize spring vertical deflection capability. Thickness throughout the Σ-spring developed length is graduated in order to minimize induced stresses, weight, and cost. Stiffness of the Σ-spring can be adjusted in compact space condition through increasing or decreasing number of turns of the Σ-spring. The Σ-spring is made of Polymeric Matrix Composite of resin strengthened by mineral clay powder providing built-in damping in addition to springing. Σ-spring of built-in damping can suspend mass passively as a stand-alone spring providing both of springing and damping, or semi-actively through two opposite Σ-springs of built-in damping providing both of springing and damping.

### BACKGROUND OF THE INVENTION

1. Field of the Invention

This invention relates generally to spring of innovative optimized shape that may be fabricated from polymeric matrix composites modified at nano-structure, metal matrix composite, or monolithic material.

Particularly, the invention relates to suspension systems, vehicle suspension systems, and vehicle dynamics. The invention also relates to damping and structural mechanics. In addition, the invention relates to applications in Micro-Electro Mechanical Systems (MEMS) and at the nano-level in Nano-Electro Mechanical Systems (NEMS).

2. Description of the Prior Art

Originally, a publication by Curtis et al., patent number U.S. Pat. No. 3,815,887, demonstrated a plastic spring in 1974. The Curtis's patent describes a thin wall hollow, corrugated plastic spring providing a telescopic effect of non-linear rate. The Curtis's plastic spring is made of Polypropylene and has primary utility in seating and reclining applications. More recently, a publication by Doller et al., patent number U.S. Pat. No. 4,850,464, published in 1989 presented a roller clutch energizing spring with protected pleats. The Dolller's patent describes an accordion type roller clutch energizing spring taking advantage of the side thrust that occurs when a spring of that type without squared off end leaves is tipped in order to fit it into the pocket.

A publication by Rose et al., patent number U.S. Pat. No. 4,805,885, demonstrated a sinuous spring in 1989. The Rose's patent describes a spring for a switch actuating assembly is of generally E-shape or sinuous configuration.

A publication by Spedding, patent number U.S. Pat. No. 5.013,013, published in 1991 showed spring assemblies. The Spedding's patent describes a zig-zag spring in the form of a strip of fiber-reinforced plastics material with limbs connected by reflex portions.

A publication by Miller, patent number U.S. Pat. No. 5,540,418, published in 1996 presented a foldable bed with collapsible sinuous springs. The Miller's patent describes a foldable bed is movable between an unfolded position, in which interconnected seat, cavity, and body sections are substantially horizontally aligned and of substantially uniform depth, and a folded position, in which the body section is horizontally disposed, the seat section is generally upright and extends between the body and seat sections.

A publication by Miller, patent number U.S. Pat. No. 5,535,460. demonstrated a spring assembly for seating and bedding in 1996. The Miller's patent describes a runner wire useful useful with collapsible springs includes a plurality of generally parallel and generally aligned runner sections.

A publication by Sancaktar, E., and Gratton, M., entitled “Design, Analysis, and Optimization of Composite Leaf Springs for Light Vehicle Applications” published in Vol. S0263-8223(98)00136-6, (1999) by Elsevier Science Ltd., featured a design of a composite leaf spring for light vehicle applications. The Sancaktar's publication describes aspects of design and manufacturing of composite leaf springs as a replacement of the traditional steel semi-elliptic multi-leaf springs.

A publication by Sardou, M A., and Ptricia, D., entitled “Light and Low Cost Composite Compression C-springs for Vehicle Suspension” published in Vol. 2000-01-0100, (2000) by The Society of Automotive Engineers (SAE), demonstrated a design of a composite spring of C-shape for vehicle suspension applications. The Sardou's publication describes aspects of design and manufacturing of composite C-springs as a replacement of both of the traditional steel semi-elliptic multi-leaf springs and the composite leaf springs.

While the art described above has advanced the art of springs design and structure, there is still a need for a spring provides superior deflection capability in compact space condition, contributes in vibration isolation, and provides controllable spring stiffness within compact space according to loading conditions while maintaining high strength-to-weight ratio, high load carrying capacity, lightweight, and low cost

Prior art spring configurations and structures failed to strike such a superior balance of desired features. Prior art spring configurations and materials are believed to provide either demonstrated deflection capabilities with large space requirements and relatively high level of induced stresses or poor deflection capabilities with compact space requirements and relatively low level of induced stresses.

Curtis et al.'s invention, patent number U.S. Pat. No. 3,815,887, has drawbacks include low load carrying capacity because of unified thickness throughout spring length, and weak deflection capability in compact space condition.

Doller et al.'s invention, patent number U.S. Pat. No. 4,850,484, has drawbacks include large space requirements because of large side movement, and low load carrying capacity because of unified thickness throughout spring length.

Rose et al.'s invention, patent number U.S. Pat. No. 4,805,885, has drawbacks include unsafe compression pattern of outer-sections of the spring due to external loading at the free ends of outer-sections because the two outer arms of the spring are initially horizontal, weak deflection capability because the U-shape of the large radius of curvature of the spring is at the line of loading at the free ends of outer-sections, no mentioning of how one can control stiffness of the spring in compact space condition through geometrical configuration of the spring at different loading levels, and no mentioning of how his invention can semi-actively suspend mass vertically.

Spedding's invention, patent number U.S. Pat. No. 5,013,013, has drawbacks include low load carrying capacity because of unified thickness throughout spring length, and weak deflection capability because of equal radius of curvature of all U-shapes of the spring. Miller's invention, patent number U.S. Pat. No. 6,540,418. has drawbacks include low load carrying capacity because of unified thickness throughout spring length, and large space requirements.

Miller's invention, patent number U.S. Pat. No. 5,535,460, has drawbacks include weak deflection capability because the spring deflection capability depends on elastic tension strain in metallic wire which is in turn very limited, and large space requirements.

3. Identification of Objects of the Invention

Accordingly, it is a primary object of the invention to provide a spring of superior deflection capability in compact space conditions.

It is another object of the invention to provide a contribution in vibration damping of mass suspended vertically.

Another object of the invention is to provide controllable spring stiffness in compact space condition according to loading conditions.

Another object of the invention is to provide high strength-to-weight ratio.

Another object of the invention is to provide high load carrying capacity.

Another object of the invention is to exhibit low cost through simple design and low cost materials of constituents.

### SUMMARY

The invention is a spring of Sigma Σ-shape that has two inclined arms in order to be horizontal while fully loaded ensuring safe compression pattern. Such spring has graduated thickness throughout spring developed length in order to minimize induced stresses whilst maintaining minimum thickness and consequently minimum weight and cost.

The spring of Sigma Σ-shape has two opposite sets of turns of different sizes in order to maximize spring vertical deflection capability. Stiffness of such spring can be adjusted in compact space condition through increasing or decreasing number of turns of the spring. The spring of spring of Sigma Σ-shape can suspend mass vertically while under static or dynamic loading condition, and can suspend mass semi-actively through curved-end of the two inclined arms of the Sigma Σ-spring as a seat for bearing load. Sigma Σ-spring is made of polymeric matrix composite of plies of aligned woven roving continuous E-glass fibers of volume percentage of 60% of composite structure impregnated in polyester resin of volume percentage of 32% of composite structure strengthened mineral day powder of volume percentage of 7.5% of composite structure in order to get high structural strength to weight ratio providing both of springing and damping.

Sigma Σ-spring invention is distinguished from the invention of composite leaf spring through its compact space requirements and reduced induced stresses. Also, Sigma Σ-spring invention is distinguished from composite C-spring invention in terms of strong deflection capability.

### BRIEF DESCRIPTION OF THE DRAWINGS

The objects, advantages and features of the invention will become more apparent by reference to the drawings that are appended hereto and wherein like numerals indicate like parts and wherein an illustrative embodiment of the invention is shown, of which:

FIG. 1 depicts an elevation view of a Sigma Σ-spring for suspending mass passively;

FIG. 2 depicts a sectional view A-A in the Sigma Σ-spring for suspending mass passively showing that the cross section throughout developed length of the Sigma Σ-spring is a rectangular cross section;

FIG. 3 depicts a side view of the Sigma Σ-spring for suspending mass passively;

FIG. 4 depicts a plan view of the Sigma Σ-spring for suspending mass passively;

FIG. 5 depicts an elevation view of Sigma Σ-spring of Built-in damping for suspending mass semi-actively under light-to-mid loading;

FIG. 6 depicts an elevation view of Sigma Σ-spring of Built-in damping for suspending mass semi-actively under heavy loading;

FIG. 7 depicts a sectional elevation view of passive Sigma Σ-spring assembled with vehicle tire and suspended mass of vehicle.

### DETAILED DESCRIPTION OF THE INVENTION

The invention of Sigma Σ-spring is dedicated to provide a superior deflection capability in compact space conditions. Moreover, the Sigma Σ-spring can contribute in vibration isolation of the suspended mass 8 while maintaining high strength to weight ratio.

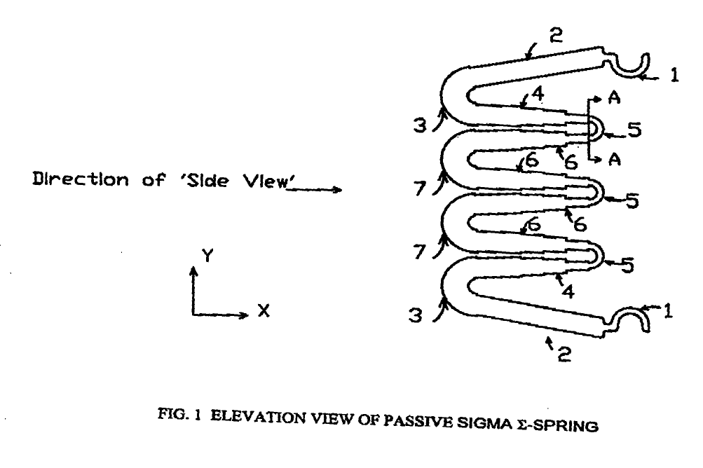

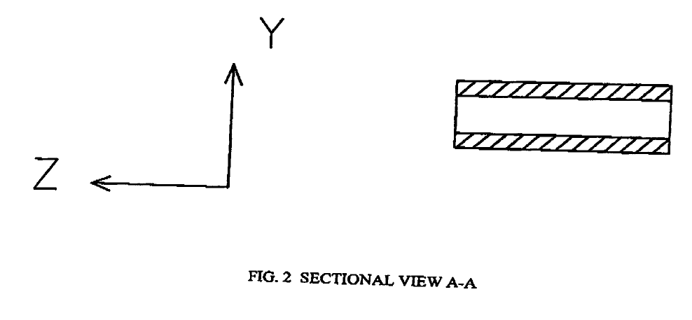

Referring to FIG. 1 which represents an elevation view of the Sigma Σ-spring, FIG. 1 shows continuous stream of the Sigma Σ-shape of the Sigma Σ-spring and how rational is the graduation of thickness throughout the developed length ranging from portions of maximum thickness 3 and 7, to middle portions of graduated thickness 4 and 6, to portions of minimum thickness 5. In addition, in the course of the compression pattern of deflection of the Sigma Σ-shape, the portions of the maximum thickness 3 and 7 move away from each other in contrast with what they are before loading since the portions of the maximum thickness 3 and 7 are very close to each other before loading. Such feature enables the possibility of increasing the thickness to an extreme extent at the critically stressed portions extending fatigue life of the spring without affecting its compression pattern of deflection. Moreover, FIG. 1 shows the symmetric inclination of the two arms 2 of the Sigma Σ-spring which translate and rotate vertically being horizontal while fully loaded in order to ensure a safe compression pattern of the Sigma Σ-spring. FIG. 1 also features how easy is fixation of the Sigma Σ-spring through resting of a protruding part of the suspended mass 8 such as a cylindrical pin 9 on the semi-half-ringed end 1 of one of the two inclined arms while the symmetric end of the other inclined arm is rested in a similar way on a dynamic excitation source such as a tire 12. This way of fixation can be used in vehicle suspension systems. Furthermore, FIG. 1 shows smartness of the Sigma Σ-shape that can have as much number of turns as required to achieve targeted stiffness. FIG. 2 which shows sectional view A-A in the Sigma Σ-spring for suspending mass passively, illustrates that the rectangular cross section is adopted throughout the developed length of the Sigma Σ-spring because of convenience of the rectangular cross section for composite plies stacking, and reduced induced stresses of the rectangular cross section due to high moment of inertia of the, rectangular cross section.

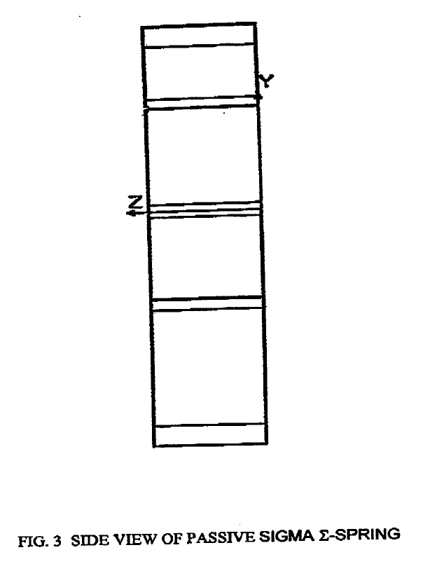

FIG. 3 is a side view of the Sigma Σ-spring for suspending mass passively. Also, FIG. 3 demonstrates how compact is the depth of the Sigma Σ-spring along with smart symmetric configuration of the Sigma Σ-spring.

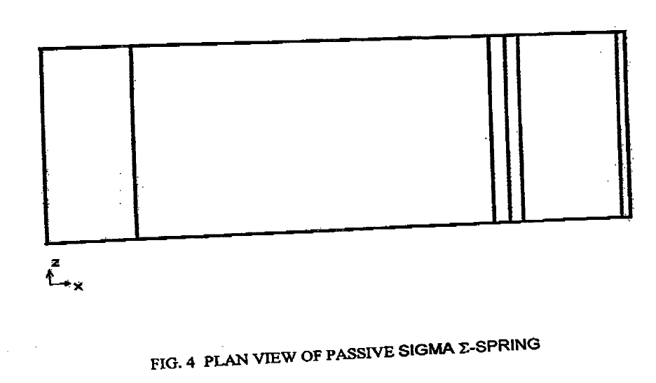

FIG. 4 illustrates a plan view of the Sigma Σ-spring for suspending mass passively. Also, FIG. 4 shows how compact are the width requirements of the Sigma Σ-spring.

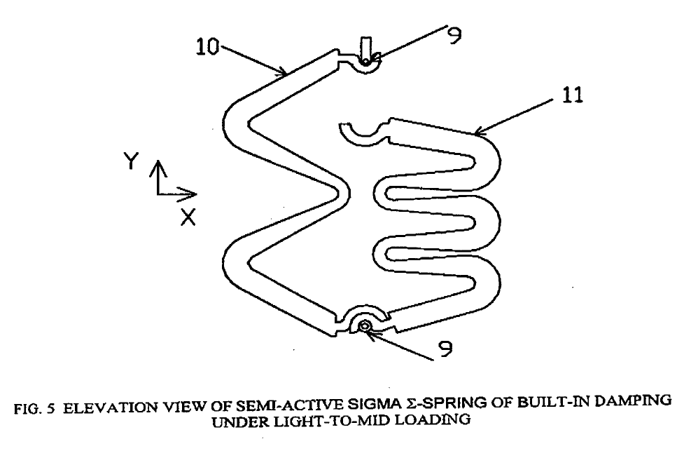

FIG. 5 demonstrates an elevation view of Sigma Σ-spring of Built-in damping for suspending mass semi-actively under light-to-mid loading. FIG. 5 illustrates two opposite Sigma Σ-springs 10 and 11 of Built-in damping under light-to-mid loading. Such suspension system can be used in vehicle suspension systems.

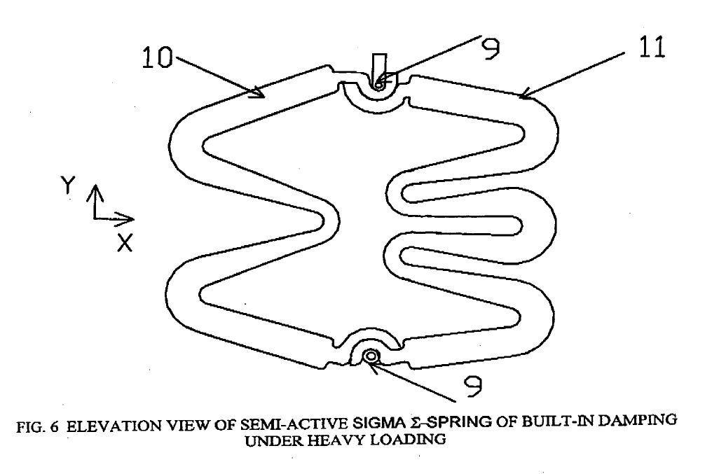

FIG. 6 illustrates the two opposite Sigma Σ-springs 10 and 11 of Built-in damping at heavy loading level. FIG. 6 also shows how smart is the deflection pattern of the Sigma Σ-springs that saves space in an inward direction allowing the two opposite Sigma Σ-springs 10 and 11 of Built-in damping to deflect without interference.

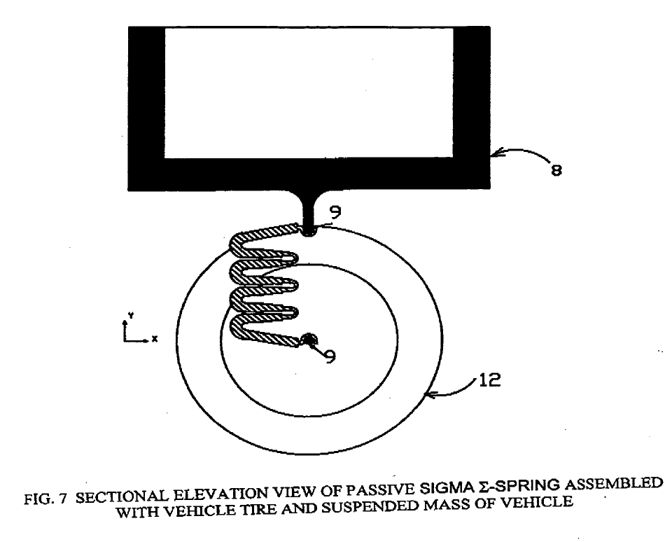

FIG. 7 demonstrates a sectional elevation view of passive Sigma Σ-spring assembled with vehicle tire and suspended mass of vehicle

Sigma Σ-spring can be composed of polymeric matrix composite of plies of aligned woven roving continuous E-glass fibers of volume percentage of 60% of composite structure impregnated in pester resin strengthened by mineral clay powder in order to get high structural strength to weight ratio with aggregate volume percentage of 39.5% of composite structure. The polymeric matrix composite Sigma Σ-spring is fabricated by thoroughly mixing mineral clay powder of volume percentage of 7.5% of composite structure with polyester resin of volume percentage of 32% of composite structure and Cobalt-based catalyst (hardener) of volume percentage of 0.5% of composite structure. The aligned woven roving continuous E-glass fibers according to space condition and targeted stiffness of the Sigma Σ-spring are then cut to and with symmetric and even number of plies in order to avoid presence of bending-stretching coupling in the laminate. Next, an open mold of the Sigma Σ-shape is coated with paste wax in order to facilitate separation of finished Sigma Σ-spring from the mold. Next the mixture of the polyester resin, the mineral clay powder, and the Cobalt-based catalyst, is applied thoroughly to the E-glass fibers plies and laid-up in the mold with stacking angles of ±45°. In order to ensure complete air removal and wet-out, serrated-rollers are used to compact the material against the mold to remove any entrapped air. Curing of resulted composite structure is achieved through chemical reaction in the resin because of the catalyst action.

What I claim as my invention is:

1. A spring of Σ-shape that resembles the capital Sigma Σ letter, above which mass can be suspended vertically while under static or dynamic loading conditions, has two inclined outer arms such that to be horizontal while fully loaded ensuring safe compression pattern and providing pre-stressed condition that reduces stress at critically stressed sections.

2. A spring of Σ-shape as set forth in claim 1, has two opposite sets of turns of different sizes one of small radius of curvature at the side of line of loading of the mass that can be suspended vertically and the opposite one has large radius of curvature in order to maximize spring vertical deflection capability.

3. A spring of Σ-shape as set forth in claim 2, has graduated thickness throughout the spring developed length in order to minimize induced stresses, weight, and cost.

4. A spring of Σ-shape as set forth in claim 3, has stiffness that can be adjusted in compact space condition through increasing or decreasing number of turns of the spring.

5. A spring of Σ-shape as set forth in claim 4, is made of Polymeric Matrix Composite of resin strengthened by mineral day powder providing built-in damping in addition to springing.

6. A spring of Σ-shape as set forth in claim 5, of built-in damping can suspend mass passively as a stand-alone spring providing both of springing and damping, or semi-actively through two opposite Σ-springs of built-in damping each of which has the same stiffness and has curved-end as a seat for bearing load on each other and one of the two opposite Σ-springs is taller than the other and acts at low-to-mid loading level whereas at heavy loading level deflects touching and consequently bearing on the other opposite one.
